(19) United States
(12) Patent Application Publication
(10) Pub. No.: US 2026/0264242 A1
(43) Pub. Date: Sep. 10, 2026

(54) GENERATING AUGMENTED TRAINING DATA FOR ROBOTIC ARTIFICIAL INTELLIGENCE MODELS UTILIZING AUGMENTED REALITY GLASSES

(71) Applicant: LabyrinthAI Inc., Boston, MA (US)

(72) Inventors: Michael HEALY, Somerville, MA (US); Craig CHENEY, Somerville, MA (US); Fabrizio SANTINI, Arlington, MA (US); Maxim ANTINORI, Arlington, MA (US)

(21) Appl. No.: 19/558,790

(22) Filed: Mar. 6, 2026

Related U.S. Application Data
(60) Provisional application No. 63/768,704, filed on Mar. 7, 2025.

(51) Int. Cl. B25J 9/16; G06F 3/01; G06T 7/11; G06T 7/246; G06T 7/73; G06T 19/00; G11B 27/34

(52) U.S. Cl. CPC B25J 9/1671; B25J 9/1605; B25J 9/1612; G06F 3/011; G06T 7/11; G06T 7/246; G06T 7/73; G06T 19/006; G11B 27/34; G06T 2207/10016; G06T 2207/20081; G06T 2207/30196

(57) ABSTRACT

Systems and methods are disclosed for generating training data for robotic artificial intelligence models using augmented reality (AR) glasses. A human operator performs a task while AR sensors capture multimodal data including RGB video, hand and arm pose trajectories, and metadata. Operator trajectories are converted into robot joint trajectories using inverse kinematics applied to parameterized robot models. A data-augmentation pipeline removes the operator using transformer-based segmentation and spatio-temporal in-painting, and inserts a to-scale robot embodiment consistent with the calculated trajectories. Real-time AR feedback enforces data-quality constraints and reduces recollection time. The system produces synchronized datasets, including raw video, augmented robot-inlaid video, and trajectory files that are suitable for training robotic AI models with reduced real-to-sim discrepancy across diverse manipulation tasks.

### PRIORITY

This application claims the benefit of U.S. Provisional Patent Application No. 63/768,704 filed Mar. 7, 2025, the disclosure of which is hereby incorporated by reference in its entirety.

### BACKGROUND

The present invention relates to the generation of training data for robotic systems from demonstrative video from an egocentric perspective.

Robotic systems increasingly rely on machine-learning-based action models to interpret visual inputs and generate appropriate motor commands. These action models are commonly trained on large volumes of annotated video data that associate observed scenes with corresponding robotic behaviors. However, obtaining high-quality training datasets remains a significant challenge. Often teleoperation of a robot is used to gather robot training data in real world settings. Real-world data collection, however, is highly labor-intensive, difficult to scale, and subject to inconsistencies in lighting, perspective, and operator technique. The inevitable disparity between real-world scenes and their digital representations in a simulator represents the loss of accuracy, visual realism, or physical fidelity when capturing a real-world environment and trying to replicate it within a virtual, simulation-based robotic environment. As a result, many existing datasets fail to capture the richness and variability required for robust autonomous performance across diverse environments.

To overcome these limitations, new methods are emerging for programmatically generating or augmenting training data that more accurately reflect the real-world operational conditions encountered by modern robotic platforms. By automating the creation of video-based action examples, and by embedding structured metadata that maps visual observations to executable behaviors, these systems can dramatically improve the efficiency, fidelity, and scalability of training pipelines.

### SUMMARY

According to an aspect of the present invention, a method of generating robotic training data for the performance of a task is herein provided. The method includes monitoring a user performing the task with augmented reality glasses, the user wearing the augmented reality glasses while performing the task to provide an AR scene, and the AR scene including a surrounding environment. The method determines a position and location of at least one hand of the user while performing the task in the AR scene's relative coordinate system, and determines the hand's pose using its position and location in that coordinate system. The method determines at least one joint angle of a robot in the relative coordinate system using the pose of the hand, generates a simulated robot as an overlay in the AR scene using the at least one joint angle and the pose of the hand, records a video of the simulated robot and the user performing the task with the surrounding environment to provide the training data.

In another aspect, augmented reality glasses are provided for training a robotic system to perform a task, the augmented reality glasses comprising an optical acquisition device, an image display device, and a processing device. The optical acquisition device is provided to acquire image data of a scene, the scene comprising the field of view of a user wearing the augmented reality glasses while the user performs the task. The image display device projects an image representation of a robot as an overlay in the scene, and the processing device receives the image data of the user when performing the task in the scene, extracts the pose of a hand of the user; and tracks the pose of the hand in the scene. The processing device also generates the simulated robot having a set of joint angles corresponding to the tracks of the pose of the hand and records the projected simulated robot to provide training data for the robotic system.

In yet another aspect, a method for determining a robot's pose in real time using augmented reality glasses is provided. The method includes the steps of acquiring a video stream of a user performing a task in a surrounding environment while viewing the performance of the task with augmented reality glasses, extracting hand tracking data of the user's hands while performing the task with the augmented reality glasses, generating a simulated robot to perform the task in real time using the hand tracking data to establish joint states of the simulated robot with the augmented reality glasses, displaying the simulated robot as an overlay in the scene to the user so as to give the user the impression that the simulated robot is performing the task and to provide an augmented video with the augmented reality glasses, and using the augmented reality glasses to extract the joint states of the simulated robot from the augmented video with the surrounding environment.

### BRIEF DESCRIPTION OF THE DRAWINGS

The following description may be further understood with reference to the accompanying drawings in which:

FIG. 1 shows an illustrative flow chart diagram of a method of the present invention;

FIG. 2 depicts an illustrative flow chart diagram of an aspect of the process of the present invention;

FIG. 3 shows an illustrative diagrammatic representation of the relationship of various aspects of the present invention;

FIG. 4 shows a flowchart representation of an aspect of the present invention;

FIG. 5 depicts an illustrative diagrammatic representation of the use of the AR glasses of the present invention;

FIG. 6 depicts an illustrative diagrammatic representation of the use of the AR glasses of the present invention to move and manipulate an object;

FIG. 7 shows the illustrative diagrammatic representation of FIG. 6 demonstrating movement and manipulation of the object;

FIG. 8 depicts a diagrammatic representation of the interrelationship of the joint angles that produce the pose of the end-effector in a robot;

FIG. 9 shows a process flowchart of the method and apparatus of the present invention addressing the interrelationships shown in FIG. 8;

FIG. 10 shows an illustrative categorical listing of features of the present invention;

FIG. 11 depicts a process known in the prior art;

FIG. 12 demonstrates an improvement over the prior art as methods of the present invention;

FIG. 13 depicts an illustrative diagrammatic representation of feedback to a user according to the methods and apparatus of the present invention;

FIG. 14 shows an illustrative diagrammatic representation of an aspect of the present invention showing a robotic overlay;

FIG. 15 depicts an illustrative diagrammatic representation of various robotic configurations;

FIG. 16 shows a representative flowchart illustrating data augmentation according to the present invention;

FIG. 17 depicts a flowchart demonstrating an illustrative process for data augmentation according to the present invention;

FIG. 18 depicts an illustrative representation of the removal of certain features in the generation of training video according to the present invention;

FIG. 19 shows illustrative diagrammatic representations of composite images of two augmented frames showing inlaid robotic devices;

FIG. 20 depicts a flowchart of an aspect of the present invention; and

FIG. 21 shows a representative illustrative example of the relationship of data generated according to the present invention.

Before one or more embodiments are described in detail, one skilled in the art will appreciate that the invention is not limited in its application to the details of construction, the arrangements of components, and the arrangement of steps set forth in the following detailed description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION

Various Artificial Intelligence (AI) techniques can be employed for controlling robots both for locomotion and manipulation. To train these AI models, a large amount of data is needed, including video, end-effector position, and force data, etc. Described herein is a method for human operators to collect robotic training data using Augmented Reality (AR) glasses, augment these data to improve quality and relevance, and process the data. These methods enable training data representative of real tasks, with a low “real to sim” gap, while allowing natural operator performance so the data captures both task intent and execution (e.g., hand pose, joint state, end-effector pose, timing) across varied scene configurations.

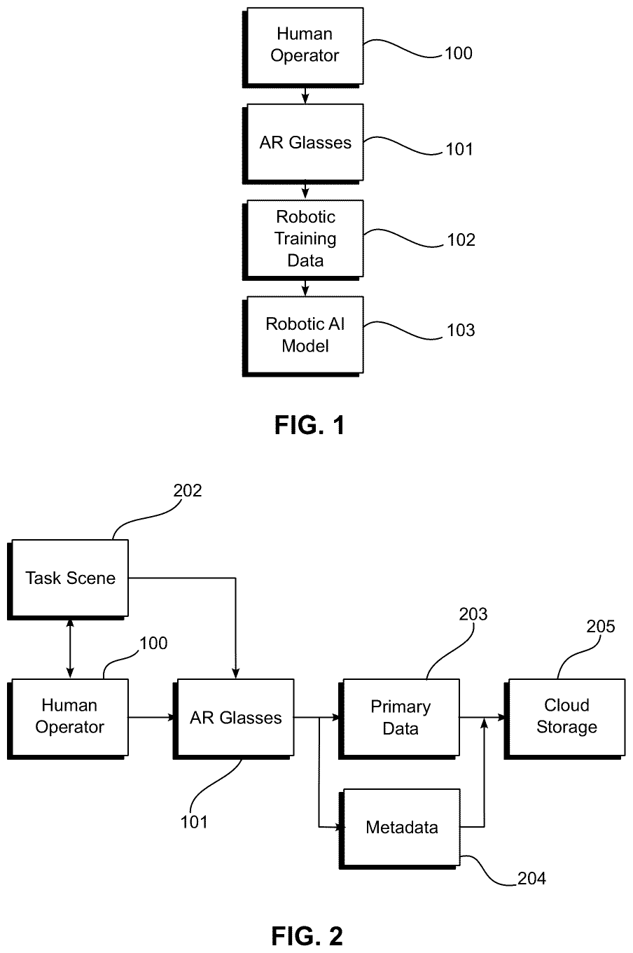

The generalized process for creating a robotic AI model (including Vision-Language-Action models) with AR is described in FIG. 1. A human operator 100 uses AR glasses 101 that generate robotic training data 102. AR glasses, as used herein, means a head-mounted display device that includes a stereoscopic RGB color view of the user's environment, whether through lenses or as “passthrough” video, that supports six degrees of freedom (6DOF) for the user's head position. Additionally, AR glasses of the type described herein support hand tracking, and alternatively, tracking provided by external tracking devices (e.g., fiducial bands worn on arms). Using this data, a robotic AI model 103 is created, and then deployed to complete one or more tasks.

FIG. 2 shows this process in expanded detail. The process begins with a human operator 100, who is completing a task. To achieve this, the operator wears AR glasses 101 and interacts with the task scene 202 through operator/scene interaction, where scene tracking is captured by the AR glasses 101 from the task scene 202 and hand tracking and/or body tracking is captured by the AR glasses 101 from the human operator 100. In some embodiments, the video captured comprises a first-person, wearer-perspective recording from outward-facing camera(s) on the AR glasses, while the operator wears the AR glasses during task execution. As the operator performs and completes the task, primary data 203 and metadata 204 are collected and uploaded to the cloud 205. In some embodiments, the primary data 203 includes at least a first-person video stream captured by the AR glasses 101 from the perspective of the operator 100 (and optionally associated audio and/or other synchronized sensor streams). Both the metadata 204 and the primary data 203 are subsequently used to train a robotic AI model (including Vision-Language-Action models).

Augmented reality data collection is particularly well-suited for tasks involving the manipulation of non-rigid objects, as the human operator has full force feedback while performing them. Force feedback allows for natural, human-like motions to be captured, which is challenging to achieve in simulations. Parsing, segmenting, and modeling of non-rigid, or mechanically compliant, objects can be challenging because the objects can dynamically deform, meaning there is no single representation of the object. Instead, the internal structure of the object must be considered. For example, the shape of a bag of dog kibble is not static and will change significantly. It can be folded along any number of axes; the shifting contents will make it bulge at the bottom, the bag will change shape with motion, etc.

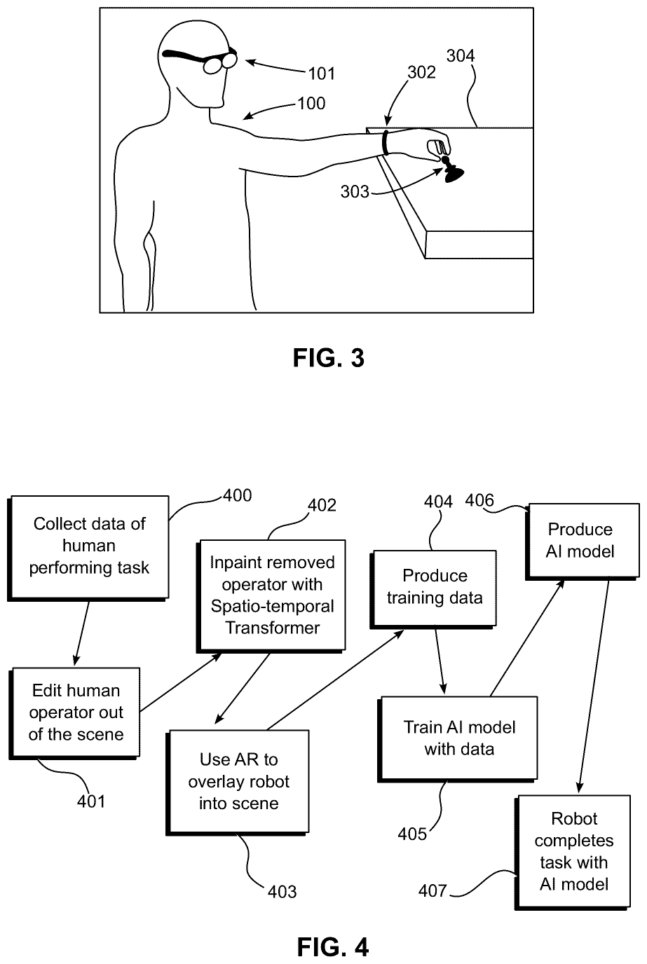

Represented in FIG. 3, a human operator 100 is shown wearing AR glasses 101. The operator 100 manipulates a task object 303 within the task scene 304, to accomplish a task. The operator 100 optionally wears an arm or wrist band 302 which can act as a reference for the AR glasses, and may include one or more cameras for additional video inputs on the arm or wrist.

Types of applications that can be completed with this system include, but are not limited to, pick and place tasks, loading and unloading boxes, depalletizing, installing wire harnesses, moving fully compliant objects, household chores, and bagging groceries.

The workflow for generating augmented data for robotic AI models is shown in FIG. 4. In the initial step 400, data are collected from a variety of sources, including AR glasses, RGB cameras, and other sensors. Then, using a transformer-based segmentation technique, the human operator is edited out of the scene at step 401 and a Spatio-Temporal transformer at step 402 is used to in-paint the removed operator. After the scene has been cleared of the operator, a realistic and to-scale model of the robot is overlaid into the scene at step 403. The overlaid robot can replace the human operator, or aspects of the human elements can remain if they are useful for post-production analysis. This model of the robot, along with other time-series data collected from the operator, are used to produce the training data at step 404. The training data are then used to train the AI model at step 405, which produces the AI model at step 406. A robot is then deployed at step 407, using in part or in whole, the generated AI model to control the robot to complete the desired task.

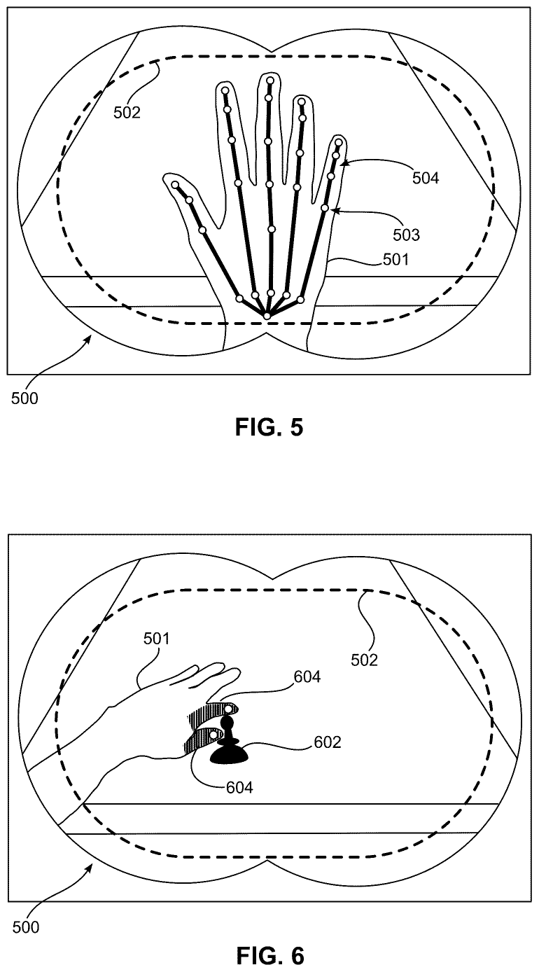

Operator Tracking. A key concept in using AR techniques to generate robotic training data is the ability to locate an operator within a space and track their hands as they manipulate objects. The illustrative diagrammatic representations provided herein show a single hand and arm performing a task, the representations are simplified for purposes of clarity. The methods and apparatus described herein are fully applicable when both hands and arms of an operator cooperate in the performance of a task. As shown in FIG. 5, an operator 100 views the task scene through the AR glasses 101, shown as indicated by the two overlapping circular masks indicating an AR frame 500, viewing the operator's hand 501. Within the active AR region 502, the system within the AR glasses 101 uses built-in sensors and associated tracking algorithms to estimate (i) the pose of the head-worn device and/or an outward-facing imaging sensor used to capture egocentric video (a “camera pose”) and (ii) hand kinematics, including individual joints 503 and links 504, and to output a position and orientation (collectively, a “pose”) for the hand 501 and/or for one or more portions thereof. The joints 503 and links 504 shown in FIG. 5 are illustrative in that some embodiments may provide up to five joints 503 per finger and four joints 503 for the thumb, with joints 503 assigned to the palm and wrist for a total of 26 joints 503. In some embodiments, the tracking runtime establishes a world-locked reference space whose origin is set automatically at tracking initialization (e.g., corresponding to the pose of the head-worn device at the time an AR session begins, or another runtime-defined zero pose), the camera pose is represented with respect to the world-locked reference space, and the hand pose and associated joint locations are recorded in a coordinate system tied to the camera (e.g., a camera coordinate frame associated with the contemporaneous video frame), such that hand/arm signals are stored as camera-relative kinematics together with the camera pose transform that relates the camera frame to the world-locked reference space.

In some embodiments, the system within the AR glasses 101 time-stamps video frames, camera poses, and hand/arm pose outputs using a common clock and/or a shared timestamping basis (or clock domains convertible to a shared time basis) so that kinematic samples can be temporally aligned to corresponding frames of an output video stream, thereby enabling post-processing and model training that associates physical execution state with time-aligned first-person visual observations. In most robotic applications, data used to train or control the robot, or react to the environment, typically comes from various sources, including image sensors, encoders, audio, and inertial measurement units. If these data streams are not perfectly aligned in space and time, a model will arrive at a distorted view of reality. For example, if a camera frame is captured at t₁ but the robot arm position is recorded at t₂, the model will learn a false spatial relationship between what it sees in the image and the action that it must generate. Accordingly, in the method and apparatus of the present invention, synchronization of the data streams is maintained to facilitate model training.

In some embodiments, in addition to optical hand tracking by the AR glasses 101 (e.g., using one or more cameras and/or depth sensors on the AR glasses 101), the system within the AR glasses 101 estimates additional arm joints using one or more supplementary modalities, including optical segmentation of the operator's arm or wrist, tracking of one or more objects worn by the operator to improve robustness, such as the arm band 302 of FIG. 3, (e.g., a band worn on an upper arm, forearm, and/or wrist), and/or inertial measurement units (IMUs). Such wearable objects may include passive and/or active features to facilitate tracking when the hand is partially occluded (e.g., when grasping an object obscured from the outward facing camera(s) of the AR glasses), and in some embodiments may further include one or more sensors or cameras to capture additional data streams or videos. In some embodiments, these additional measurements are recorded with timestamps in the same time basis as the egocentric video (and, where present, audio), enabling spatiotemporal synchronization across modalities for downstream alignment, segmentation, and learning.

As shown in FIG. 6, an operator is looking through the AR glasses to show the AR frame 500 and using their hand 501 to manipulate an object 602 within the active region 502. The operator has selected a 2-finger robotic manipulator for this task, and their fingers are recognized as the manipulator by the manipulator points 604, indicated to the operator by highlighting the fingers.

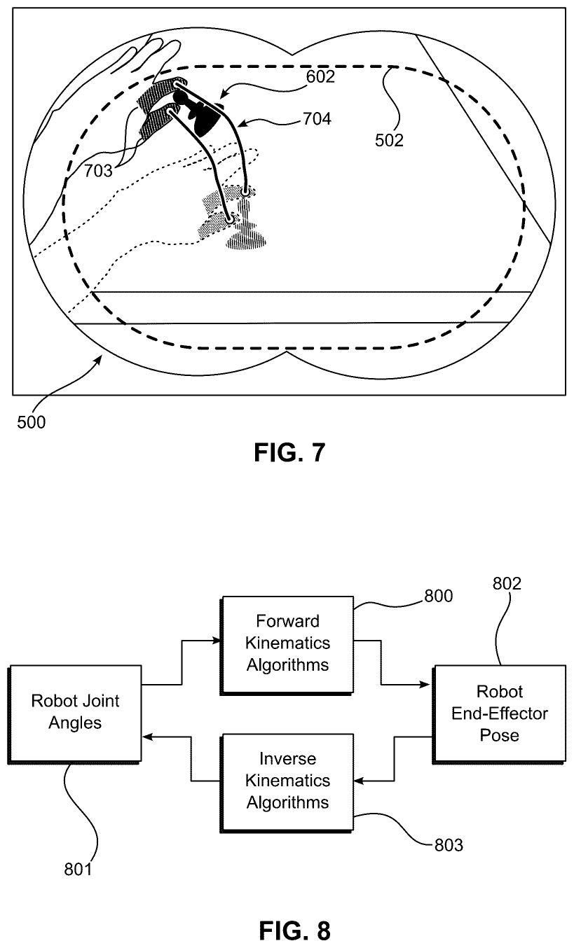

In FIG. 7, after grasping the object 602, the operator moves or manipulates it, within the active region 502 of the AR frame 603. The AR application tracks the manipulator points 703 as they move, generating and saving the resulting object trajectories, represented as their 3D paths 704. Operators may use a single hand, both hands, handheld tools, or any combination thereof to interact with objects in the scene.

Robot Trajectories. Broadly speaking, there are two reference domains useful for describing a robot's location in space. The joint angles of the robot describe the absolute angles of each subsequent joint of the robot. The first angle, denoted, for example, as q₁, is the angle between the base of the robot and the first link of the robot. Angle two, q₂, is the angle between the first and second link of the robot, and so on. Using these angles, the position of the robot's end-effector can be calculated using forward kinematics and trigonometry to calculate where each joint of the robot is. Then, the end-effector's position and orientation (collectively referred to as the pose) in Cartesian coordinates can be determined. Solving this type of equation is referred to as Forward Kinematics (FK), and there exists one unique solution for the pose of the end-effector, given the root joint angles. An Inverse Kinematics (IK) problem is the reverse of the FK problem; given the pose of a robot's end-effector, calculate the joint angles that produce the pose. IK problems in general have multiple solutions. FIG. 8 shows from a high level how to convert between the two domains. Forward kinematic algorithms 800 convert from robot joint angles 801 to robot end-effector poses 802, whereas the inverse kinematic algorithm 803 converts from poses 802 back into angles 801. Both FK and IK algorithms are well understood and widely utilized in the field of robotics.

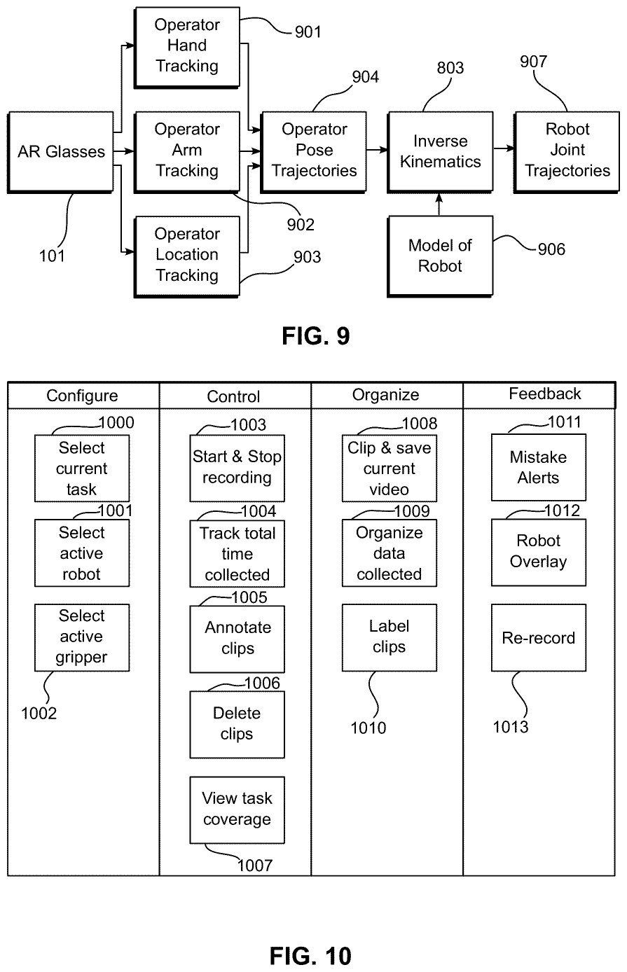

When generating high-quality training data, a key element is the capability of turning operator trajectories into robot trajectories, the process of which is shown in FIG. 9. While wearing the AR glasses 101, the operator's hands are tracked 901, arms are tracked 902, and the operator within the space is tracked 903. These data are then joined together to create the operator pose trajectories 904. Then, using IK algorithms 803 in tandem with a model of the robot 906, such as the industry standard Unified Robot Description Format (URDF) files, the operator's pose trajectories can be converted into the robot joint trajectories 907. These robot joint trajectories 907 are saved and used in future data augmentation steps, as well as used for AI model training. Using the operator pose trajectories 904, many different robot models can be independently applied to create robot joint trajectories 907 specific to a desired robot model. A single operator pose trajectory therefore can be converted into an arbitrary number of robot joint trajectories 907 provided with an arbitrary number of different robot models 906.

AR Application and Real-time Feedback. An AR application guides users through collecting data by providing a User Interface (UI). The key features of this application can be seen in FIG. 10 and can be sorted into four major categories: configuration, control, organization, and feedback. Configuration features include the initial setup of the task when the operator selects which task they are about to perform 1000, which robot is targeted for the data collection 1001, and which gripper is desired for the task 1002.

During data collection, control functions include enabling the operator to start and stop recording 1003 and presenting progress indicators, such as a total amount of data collected for a selected task 1004. Organization and feedback functions include enabling the operator to create, review, and annotate recorded clips 1005 during, and/or after capture, including attaching metadata such as spoken annotations (and derived transcripts), typed text, screenshots, and/or tags, so that the collected clips include additional contextual information for post-processing and for training machine-learning models, including vision-language-action models.

In some embodiments, the AR glasses include (as built-in or separate accessories) (i) one or more outward-facing image sensors configured to capture egocentric video and (ii) one or more microphones configured to capture user speech as an audio stream concurrent with the egocentric video. The one or more microphones may include a single microphone or a multi-channel microphone array disposed on the device. While the egocentric video is captured, the system time-stamps and/or synchronizes the audio samples and video frames using a common clock and/or shared timestamping (or clock domains convertible to a shared time basis), thereby enabling temporal alignment of portions of the audio stream and derived transcripts with specific time windows and/or frames of the clip; optionally, one or more audio front-end processes (e.g., beamforming, noise suppression, and/or side-talk rejection) are applied to the microphone signals prior to transcription.

In some embodiments, speech-to-text processing is performed by the processing circuitry within the AR glasses 101 and/or by a remote computing system to generate one or more text transcripts corresponding to the spoken annotations, and each transcript is stored as natural-language metadata associated with the clip and temporally aligned to the clip timeline (e.g., via start and end timestamps and/or per-word timing). In some embodiments, the operator is presented with a review interface to correct an initial automated transcription and/or supplement annotations, and the corrected transcription is stored as updated metadata associated with the clip.

In some embodiments, the operator initiates and terminates voice annotation using an input mechanism on the head-worn device (e.g., a mechanical button, a touch-sensitive region, a gesture, and/or a voice command), and in response the system defines a corresponding annotation segment, stores the associated portion of the audio stream (or a reference thereto), and associates the annotation segment with a clip identifier and a corresponding time interval within the clip. In some embodiments, the operator provides dense voice annotations at a fine time scale (e.g., per sub-step), and the system stores each utterance as a separate annotation item including start and end timestamps to enable retrieval of particular moments in the clip by searching or filtering text phrases.

These annotations and metadata can be used for post-processing and for training AI models (including vision-language-action models) by providing temporally grounded language context describing the scene, objects, and task aligned with the operator's actions in the clip. In some embodiments, the operator initiates and terminates voice annotation using an input mechanism on the AR glasses (e.g., a mechanical button, a touch-sensitive region on a temple, a gesture, or a voice command such as “Start Task”). In response, the system within the AR glasses 101 (i) marks a corresponding annotation segment, (ii) stores the associated segment of the audio stream, and (iii) associates the segment with the clip identifier and a time interval within the clip.

In some embodiments, a method comprises: capturing egocentric video via a head-worn device; capturing an audio stream via one or more microphones on the head-worn device during capture of the egocentric video; receiving spoken natural-language annotations from an operator; generating, using speech-to-text processing, one or more text transcripts corresponding to the spoken annotations; associating each transcript with at least one timestamp or time window of the egocentric video; and storing the transcript as metadata associated with the egocentric video. In some embodiments, the operator provides dense voice annotations at a fine time scale (e.g., per sub-step), and the system stores each utterance as a separate annotation item including a start timestamp and an end timestamp thereby enabling retrieval of particular moments in the clip by searching or filtering text phrases (e.g. Start Task, End Task).

Operators can additionally use the AR application for organizing saved data. They can delete existing clips 1006, view the amount of task coverage 1007, create new clips and save the current task data 1008, organize the existing collected data 1009, and label, or otherwise provide tags and metadata to previously recorded data 1010. The AR application also provides real-time feedback to users as they are collecting data. These feedback mechanisms are important for ensuring high-quality data is collected with minimal mistakes that could require the recollection of the data. These feedback features include alerting the users of mistakes 1011, displaying the robot overlay 1012 to ensure that the robot is in an appropriate configuration for the given task, and that the robot is not colliding with the surrounding environment or intersecting itself. If mistakes do occur, the application can suggest that the clip be re-recorded 1013.

These features can be achieved through a variety of UI elements including AR graphics, voice commands, hand gestures, audio cues, and AR eye tracking features.

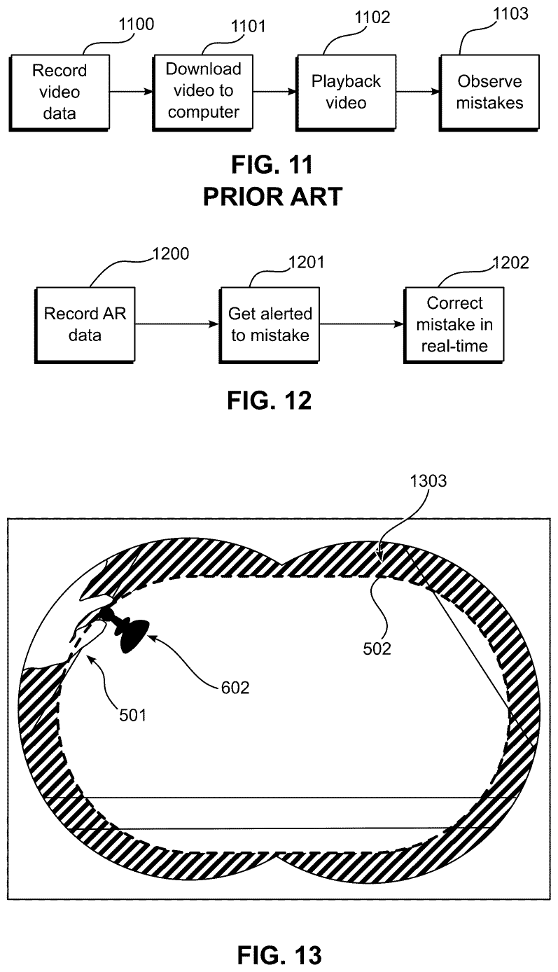

One of the key benefits of collecting robotic training data with AR glasses 101 over traditional video recording methods, is that it enables the option to provide feedback to the user in real-time while collecting the data. FIG. 11 shows a traditional method whereby an operator uses a camera to record themselves completing a task 1100. After the task is complete, the operator can download the video to a computer 1101 and then watch the playback 1102, looking for any mistakes that might have occurred 1103. Traditionally, if any mistakes are observed, the operator needs to go back to the beginning of the process and recollect the erroneous data 100. This process is time-consuming, with the feedback cycle time on the order of hours or even days. When collecting thousands of hours of training data, the cycle time can be prohibitively long.

However, using the AR data collection methods of embodiments of the present invention can tighten this feedback loop to real-time. As shown in FIG. 12, when collecting AR data 1200, an operator is alerted in real time when they make a mistake 1201, allowing them to immediately correct the mistake in real time 1202.

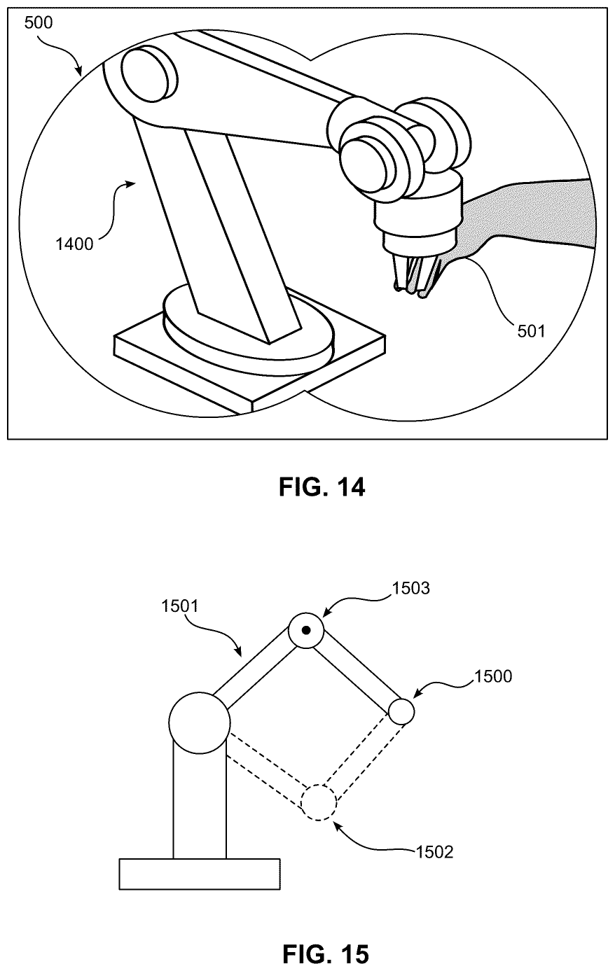

Different types of mistakes can include the operator going out of the frame, moving too quickly, leaving the robot's workspace, moving in ways that introduce self-collision of robot joints, and improperly occluding the operator's hands. FIG. 13 shows an illustrative example where the operator's hands 501 are manipulating an object 602. However, when the operator takes the object(s) out of the active region 502, they are alerted to this mistake in real-time by an audio-visual UI element 1303, such as a flashing red region (depicted in FIG. 13 as a hatched area) that provides a visual cue for the operator needs to return to the active area.

Types of alerts to indicate to the operator that a mistake occurred can include visual UI elements in the AR application, auditory chimes, and haptic feedback, such as vibrations, from the AR glasses 101.

An additional real-time feedback feature unique to the AR application is that it can be combined with the inverse kinematics previously discussed to provide the operator with an AR visual overlay of the selected robot, that moves with the operator's hand 501 as though it were being simultaneously controlled by the operator. FIG. 14 shows an AR overlay of a robot 1400 moving in real-time with the operator's arm and hand 501, from the perspective of the operator, as they look through the AR frame 500.

The ability for the operator to see the robot in real-time, overlaid in AR provides an additional mechanism for the operator to ensure that they are completing the task in a reasonable manner for any given robot, and that the resulting data will have a low “real-to-sim” gap, likely resulting in good training data for the AI model. A real-to-sim gap refers to the difference between a simulated environment and real life, which is often an issue when using entirely simulated data. By providing a visual representation of the robot to the operator, the operator can see the robot and the workspace it can extend into. When using inverse kinematics to generate the position of the robot, there are usually multiple valid solutions, as seen in FIG. 15. If the robot is attempting to get its end-effector into the position shown in 1500, it can take the top configuration 1501, or the bottom configuration 1502, both of which result in the same end-effector position. While completing a task, the operator can manipulate the AR representation of the robot by adjusting UI controls that affect the joints of the robot, for example 1503, to achieve the best performing configuration of the robot.

Data Augmentation. Data augmentation is a technique that applies various transformations or modifications to existing data without altering the fundamental meaning of the training data. These augmentation processes can be used to artificially increase the diversity and size of datasets by changing aspects of the video scene, such as robot type, gripper type, lighting, contrast ratio, and by adding or eliminating objects from the video data. The inclusion of augmented data improves model generalization and robustness, addresses challenges such as limited real-world training data and overall dataset imbalance, reduces overfitting and enhances model performance.

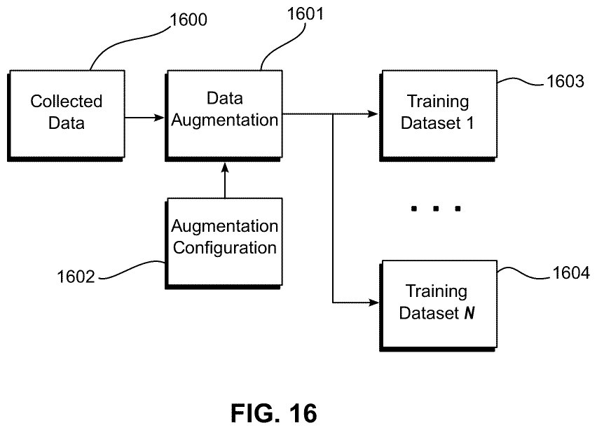

After the task data has been collected and saved, it undergoes a data augmentation process that targets it towards a specific robot embodiment. As seen in FIG. 16, the same collected data 1600 can be augmented and exported multiple times. The data augmentation step 1601 is applied to collected data based and executed based on an augmentation configuration 1602. Each time that a dataset is augmented with a unique configuration, it produces a new training dataset, 1603, up to an unlimited number N 1604. This means that the same collected data can produce many different training datasets.

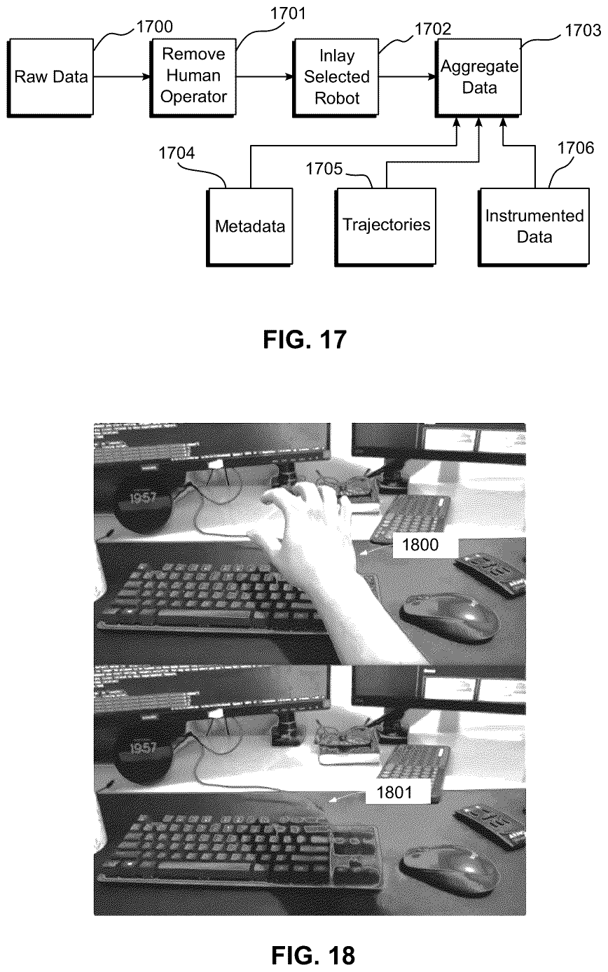

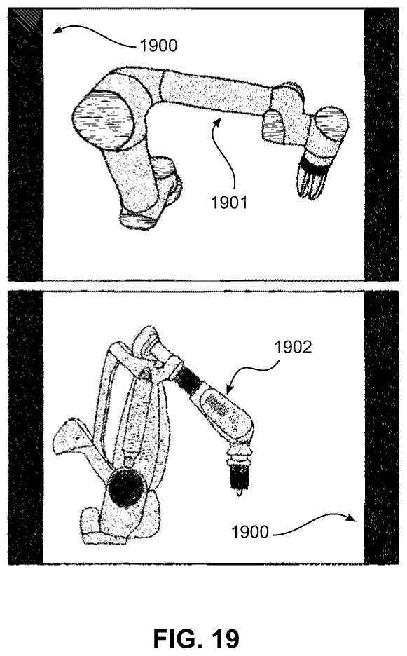

One of the primary features of augmentation is to inlay the robot model that was generated with inverse kinematics and displayed to the operator during collection. The augmentation process is shown in FIG. 17. The process starts by taking the raw data 1700 and editing out the human operator 1701 using a transformer to segment where the operator is, and then using a spatio-temporal transformer to in-paint the pixels that were removed. Then, depending on the configuration, a model of the robot is inlaid into the video 1702 using a solution calculated by solving the inverse kinematics problem. Combined with the metadata 1704, hand, arm, and wrist trajectories 1705, and additional instrumented data from the scene 1706, which may include force data, IMU data, or additional camera data, the aggregated data 1703 is created. This uses the inverse kinematics and operator pose that were previously collected. The robot that is inpainted does not have to be the same robot that was visible to the operator during collection time. An example of removing the operator from the scene can be seen in the composite image FIG. 18, where in the unprocessed image at the top the human operator's arm is visible 1800, and in the processed image on the bottom the arm has been removed 1801. FIG. 19 shows a composite image of two augmented frames, denoted by the vertical bars 1900, where two different robots are inlaid, the first one being 1901 and the second being 1902.

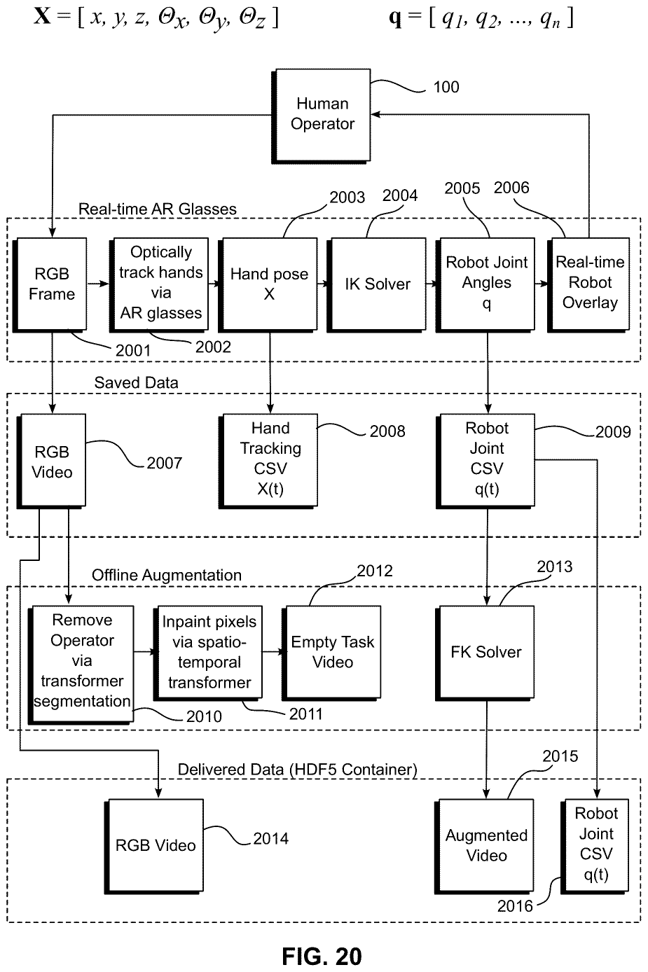

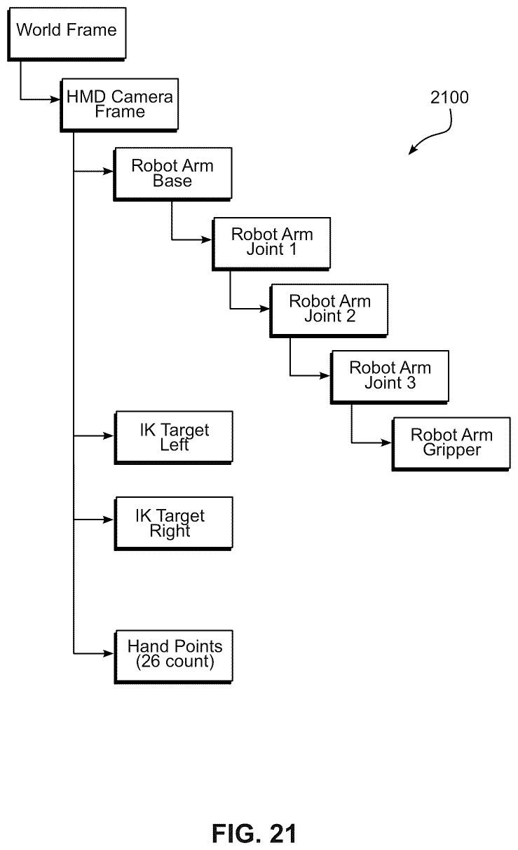

FIG. 20 shows the full end-to-end pipeline for using AR collection techniques to gather the data, augment the data, and produce the training data. The human operator 100 uses the AR glasses to record the RGB video data 2001. The AR glasses then optically track the operator's hands 2002 which calculates the pose of the hand pose X 2003. This pose, in combination with a model of the robot being targeted is passed into the IK solver 2004, which produces the robot joint angles q 2005. Based on the calculated joint angles, the robot is overlaid into the AR scene 2006, which the operator can see and verify produces realistic results. The data saved from data collection includes the RGB video 2007, a table of the hand-tracking X(t) 2008 in CSV, or a comparable format, and the calculated robot joint trajectories q(t) 2009. The file format for the hand tracking X(t) 2008 and calculated robot joint trajectories q(t) 2009 can be in absolute coordinates or in relative coordinates from the hierarchical chain corresponding to the robot and/or human hand elements, for example, in the coordinate frame relationships 2100 as shown in FIG. 21. The world frame is set as the position of the AR glasses 101 when the tracking system is first initialized. The actual number of robot joints is variable and specific to the selected robot.

With continued reference to FIG. 20, once all the data has been collected, offline data augmentation is performed to target the training data to a specific robot. The first step of augmentation is to segment and remove the human operator, which is achieved using a transformer 2010. Then, using a spatio-temporal transformer, the removed pixels are infilled 2011, which results in the empty task video 2012, which no longer contains the operator. Using the previously calculated joint trajectories q(t) 2009, the forward kinematics problem is solved 2013 resulting in the unique robotic solution. The outputs of this process are the raw RGB video 2014, the augmented video that contains the robot 2015, and the robot joint trajectory CSV 2016. These data are aggregated and time-synchronized within a data container format such as HDF5. These data are then ready for ingestion into an AI training model which can be utilized by a robot to complete similar tasks to ones in the training data.

The steps of a method or algorithm described in connection with the embodiments disclosed herein may be embodied directly in the AR glasses 101 hardware, in a software module executed by a processor, or in a combination of the two. A software module may reside in one or more RAM memory, flash memory, ROM memory, EPROM memory, EEPROM memory, registers, hard disk, a removable disk, a CD-ROM, or another form of computer-readable storage medium. An exemplary storage medium may be coupled to the processor so that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The processes described above may be embodied in, and fully automated via, software code modules executed by one or more general-purpose or special-purpose computers or processors. The code modules may be stored on one or more of any type of computer-readable medium or other computer storage device or collection of storage devices. Some or all of the methods may alternatively be embodied in specialized computer hardware.

The methods and tasks described herein may be performed and fully automated by a computer system. The computer system may, in some cases, include one or more distinct computers or computing devices (e.g., physical servers, workstations, storage arrays, etc.) that communicate and interoperate over a network to perform the described functions. Each such computing device typically includes a processor (or multiple processors, circuitry, or a collection of circuits, e.g. a module) that executes program instructions or modules stored in a memory or other non-transitory computer-readable storage medium. The various functions disclosed herein may be embodied in such program instructions, although some or all the disclosed functions may alternatively be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips and/or magnetic disks, into a different state.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes.

Those skilled in the art will appreciate that numerous modifications and variations may be made to the above disclosed embodiments without departing from the spirit and scope of the present invention.

What is claimed is:

1. A method of generating robotic training data for the performance of a task, the method comprising:
monitoring a user performing the task with augmented reality glasses, the user wearing the augmented reality glasses while performing the task to provide an AR scene, the AR scene including a surrounding environment;
determining a position and a location of a hand of the user while performing the task in a relative coordinate system of the AR scene;
determining a pose of the hand using the position and the location of the hand in the relative coordinate system;
determining at least one joint angle of a robot in the relative coordinate system using the pose of the hand;
generate a simulated robot as an overlay in the AR scene using the at least one joint angle and the pose of the hand; and
recording a video of the simulated robot and the user performing the task with the surrounding environment to provide the training data.

2. The method of claim 1, wherein determining the position and the location of the hand further comprises estimating hand kinematics including individual finger joints and links and outputting a hand pose in a camera-relative coordinate frame time-aligned to a camera pose of the augmented reality glasses.

3. The method of claim 1, further comprising establishing a world-locked reference space for the AR session and recording a transform between the camera-relative coordinate frame and the world-locked reference space so that the hand pose is storable as camera-relative kinematics with a corresponding camera-to-world transform.

4. The method of claim 1, further comprising time-stamping the position and location of the hand of the user with at least one sensor stream.

5. The method of claim 1, wherein determining at least one joint angle of a robot comprises applying inverse kinematics to a parameterized robot model specified in a Unified Robot Description Format (URDF) file, and producing joint trajectories from time-varying hand poses.

6. The method of claim 1, further comprising removing the user from the video by segmenting the user using a transformer-based video segmentation model and spatio-temporal in-painting of removed pixels to generate an operator-free task video.

7. The method of claim 6, wherein generating the operator-free task video is performed in real time.

8. Augmented reality glasses for training a robotic system performing a task, the augmented reality glasses comprising:
an optical acquisition device for acquiring image data of a scene, the scene comprising a field of view of a user wearing the augmented reality glasses while the user performs the task;
an image display device to project an image representation of a simulated robot as an overlay in the scene;
a processing device that receives the image data of the user when performing the task in the scene, extracts a pose of a hand of the user; and tracks the pose of the hand in the scene;
the processing device generating the simulated robot having a set of joint angles with an end-effector corresponding to the tracks of the pose of the hand;
the processing device projecting the simulated robot with the set of joint angles corresponding to the end-effector that tracks of the pose of the hand as an overlay in the scene on the image display device; and
the processing device recording the projected simulated robot to provide training data for the robotic system.

9. The augmented reality glasses of claim 8, wherein the processing device time-stamps video frames, camera poses, and hand/arm kinematics using a shared clock to enable frame-accurate temporal alignment across modalities.

10. The augmented reality glasses of claim 8, further comprising at least one microphone to capture wearer speech and a speech-to-text module configured to generate transcripts of spoken annotations and associate the transcripts with timestamps or time windows of the acquired video.

11. The augmented reality glasses of claim 8, wherein extracting the pose of the hand further comprises fusing optical hand tracking with at least one supplementary modality selected from: an arm-worn fiducial band, an inertial measurement unit (IMU), and wrist-mounted image sensors.

12. The augmented reality glasses of claim 8, wherein the image display device renders a real-time robot overlay responsive to the user's hand motion, and the processing device evaluates robot kinematic constraints including joint limits, self-collision, and workspace reachability to provide real-time feedback.

13. The augmented reality glasses of claim 8, wherein the processing device is configured to detect data-quality conditions comprising at least leaving an active capture region, excessive end-effector velocity, and occluded hands, and to issue visual and auditory alerts prompting corrective action.

14. The augmented reality glasses of claim 8, wherein the processing device stores, for each recorded clip, (i) the raw egocentric RGB video, (ii) hand pose trajectories X(t), (iii) robot joint trajectories q(t) generated from inverse kinematics, and (iv) metadata including user annotations and configuration of robot and gripper embodiments.

15. A method of determining a pose of a robot in real time with augmented reality glasses, the method comprising:
acquiring a video stream of a user performing a task in a surrounding environment while viewing the performance of the task with augmented reality glasses;
extracting hand tracking data of at least one hand of the user while performing the task with the augmented reality glasses;
generating a simulated robot to perform the task in real time using the hand tracking data to establish joint states of the simulated robot with the augmented reality glasses;
displaying the simulated robot as an overlay in the scene to the user so as to give the user the impression that the simulated robot is performing the task and to provide an augmented video with the augmented reality glasses; and
using the augmented reality glasses to extract the established joint states of the simulated robot from the augmented video with the surrounding environment.

16. The method of claim 15, wherein generating the simulated robot includes solving inverse kinematics in real time and displaying, to the user, multiple alternative joint configurations for a common end-effector pose with a user-selectable preference to resolve inverse kinematics redundancy.

17. The method of claim 15, further comprising enforcing capture constraints during the task by evaluating end-effector trajectories against a predefined active region and issuing an alert when a current pose or velocity violates the constraints.

18. The method of claim 15, wherein using the augmented reality glasses to extract the pose of the simulated robot further comprises applying forward kinematics to the joint angles to compute end-effector poses for storage in the training dataset.

19. The method of claim 15, further comprising augmenting at least one recorded clip by (i) removing the user via segmentation and spatio-temporal in-painting, (ii) inlaying a robot embodiment that is different from the embodiment displayed during capture, and (iii) varying at least one scene attribute including lighting, contrast, and background objects.

20. The method of claim 15, wherein the augmented reality glasses associate spoken natural-language annotations with sub-steps of the task via start and end timestamps, and store corrected text transcripts as temporally grounded metadata that is retrievable by text search.
